(19) United States
(12) Patent Application Publication
(10) Pub. No.: US 2026/0233474 A1
(43) Pub. Date: Aug. 13, 2026

(54) FIBER APPLICATION MACHINE WITH PARTICULAR FIBER CONVEYING MEANS

(71) Applicant: CORIOLIS GROUP, QUEVEN (FR)

(72) Inventor: Emmanuel LE MENEAH, Clohars Carnoet (FR)

(21) Appl. No.: 19/116,230

(22) PCT Filed: Sep. 29, 2023
(86) PCT No.: PCT/FR2023/000149

§ 371 Date: Mar. 24, 2026

(30) Foreign Application Priority Data
Oct. 5, 2022 (FR) FR2210198

(51) Int. Cl. B29C 70/38; B29C 70/54

(52) U.S. Cl. CPC B29C 70/384; B29C 70/54

(57) ABSTRACT

A fiber application machine comprising a fiber application head, fiber storage means, and routing means for routing at least one fiber from storage means to the application head, comprising at least one flexible routing tube. Each routing tube is capable of receiving a fiber in its internal passage, and is mounted by a downstream end to a downstream fixing system mounted on the application head. The routing means further comprise a guiding device comprising a chain assembled to the downstream fixing system and comprising a succession of rigid segments hingedly mounted to each other via articulation systems. The routing tube(s) pass through guide means distributed along the chain.

### CROSS-REFERENCE TO RELATED APPLICATIONS

The present application is a U.S. National Phase application of PCT Application No. PCT/FR2023/000149, filed Sep. 29, 2023, which claims the benefit of French Application No. 2210198, filed Oct. 5, 2022, which applications are hereby incorporated by reference.

### TECHNICAL FIELD

The present invention relates to a fiber application machine for the manufacture of composite material parts, and more particularly to particular fiber conveying means of such a machine for conveying fibers between fiber storage means and an application head. The invention also relates to a method for manufacturing composite material parts by means of a corresponding machine.

### BACKGROUND

Fiber application machines, commonly referred to as fiber placement machines, are known for the application by contact on a lay-up tool, such as a male or female mold, of a wide band formed of several continuous flat fibers, of the ribbon type, dry or impregnated with thermosetting or thermoplastic resin, in particular carbon fibers, made up of a multitude of carbon threads or filaments.

These machines comprise a system for displacing a fiber application head, said head comprising an application roller intended to come into contact with the mold to apply the band and means for guiding the fibers onto said application roller, fiber storage means, and means for conveying the fibers from said storage means to the application head.

In patent document WO 2012/160270, it was proposed to use conveying means comprising first flexible tubes, each flexible tube being able to receive a fiber in its internal passage. The ends of the first flexible tubes are attached to upstream and downstream attachment systems, and are of sufficient length and flexibility not to restrict the movements of the head displacement system. Each flexible tube is provided with at least one longitudinal flexible blade of rectangular cross-section, said flexible blade being arranged substantially parallel to the transport plane of the fiber received in the internal passage of the flexible tube. Flexible tubes of this type are simple to design, take up limited space and reduce costs, making it possible to obtain high running speeds, to move the storage means away from the displacement system, to avoid motorized slack recovery systems for the fiber spools, to isolate the fibers from the outside, and to simplify the displacement system for the application head, in particular to use a displacement system such as a poly-articulated arm of the six-axis robot type. The flexible blade associated with each tube limits or prevents transverse flexion of the tube in the plane of the blade, which makes it possible to eliminate, or at least limit, the risks of turning of the fiber arranged in the internal passage of the flexible tube in a parallel arrangement to the blade, in particular during certain movements of the robot, due to excessive flexion of the flexible tubes and/or excessive friction of the fibers in the flexible tubes. The flexible tube can perform flexion movements in a direction perpendicular to the plane of the blade and torsion movements to allow the fiber placement head to move in all directions. The assembly of the first flexible tube and a separate blade is achieved by a second flexible tube, this assembly system holds the blade substantially in contact with the flexible tube while allowing relative longitudinal movement of the flexible blade with respect to the first tube. The second flexible conveying tube provides a sliding-type connection between the first flexible delivery tube and the flexible blade. During the lay-up of complex shaped parts, the flexible tubes fitted with their flexible blades can be subjected to significant flexion and torsion forces which can lead to damage, particularly at the level of the assembly of the flexible blades to the attachment systems.

To reduce the longitudinal flexion of the flexible tube in the direction perpendicular to the plane of the blade at the outlet of the attachment systems, it was proposed in the above-mentioned document to equip the attachment systems with stiffening blades. These stiffening blades are mounted on the attachment systems on either side of the conveying tube, and come into abutment on one side against the conveying tube, and on the other side against the flexible blade. However, the mounting of these stiffening blades is difficult to implement.

### SUMMARY

The purpose of the present invention is to propose a machine provided with conveying means which guarantee good fiber conveying, and which are simple to make and robust.

To this end, the present invention proposes a fiber application machine comprising
a fiber application head, preferably comprising an application roller and means for guiding the fibers on said roller,
preferably a displacement system for displacing the fiber application head
fiber storage means, and
conveying means for conveying at least one fiber from said storage means to the application head, said conveying means comprising at least one flexible conveying tube, for example connecting the storage means to the application head, each conveying tube being able to receive a fiber in its internal passage, said conveying tube being mounted by a downstream end to a downstream attachment system mounted on the application head and by an upstream end to an upstream attachment system, for example mounted at the storage means,

characterized in that the conveying means further comprise a guide device comprising
a chain comprising a succession of rigid segments mounted so as to be articulated to one another via articulation systems, the said chain extending from an upstream end to a downstream end by which the said chain is connected to the downstream attachment system, and
guide means distributed along the chain in which the conveying tube or tubes pass.

This guide device according to the invention makes it possible to control the radius of curvature of the conveying tubes, in particular at the level of the downstream attachment system. It avoids excessive stresses on the end portion of the conveying tube, which could lead to a deterioration of the conveying tube and/or of its possible associated blade, and thus makes it possible to offer a more robust conveying system.

In an embodiment, the chain can extend as far as the upstream attachment system. In the case of a machine comprising a displacement system formed by a polyarticulated robot carrying the head, and conveying means for conveying the fibers to the head from storage means, formed for example by a creel of spools, positioned next to the robot, the chain can be terminated before the storage means.

In an embodiment, the chain comprises rigid segments mounted so as to be articulated to one another via articulation systems of the ball-and-socket joint type, for example with one ball-and-socket joint or two ball-and-socket joints, each articulation system preferably comprising stop means for limiting the inclination between two successive segments. The use of such ball-and-socket joint systems, also known as spherical joints, makes it easy to move the conveying tubes using a robot's wrist, while guaranteeing perfect control of the curvature of the conveying tubes. In an embodiment, segments of different lengths can be used along the chain, the chain preferably allowing a smaller radius of curvature at the downstream attachment system.

In an embodiment, the chain is formed by a succession of segments, each segment comprising at its end a convex part with a spherical surface and a concave part with a spherical surface, the concave part of a segment receiving the convex part of an adjacent segment to form a ball-and-socket joint between the two segments. The articulation system is then formed by the concave and convex parts of the segments. In this case, guide means, for example formed by guide rings, are mounted on the segments. According to an alternative, the chain comprises two types of segment, first segments provided with two convex parts and second segments provided with two concave parts, the chain then consisting of alternating first and second segments.

According to another embodiment, the articulation system comprises a rigid intermediate piece interposed between two successive rigid segments, an intermediate piece and a segment being articulated together by a ball-and-socket joint, for each ball-and-socket joint, a first element among the intermediate piece and the rigid segment is provided with a convex part having a spherical surface, the other element being provided with a concave part having a spherical surface and able to receive said convex part, intermediate pieces preferably being equipped with said guide means. The guide means mounted at the level of the articulation systems between two segments guarantee good guidance of the conveying tubes along the chain. In addition, the integration of the guide means in the intermediate piece enables the guide device to be assembled quickly and easily, as the guide means and an intermediate piece can be formed in a single piece, for example from a plastic material. In addition, each intermediate piece connected by ball-and-socket joints to the two adjacent segments is mounted so that it can rotate freely relative to the two segments. In this way, the conveying tubes passing through the guide means can pivot around the chain, making it easier to move the conveying tubes during the displacement of the robot. In another embodiment, the guide means can be mounted on the segments.

In an embodiment, the ends of the segments comprise two convex parts, each with a convex surface, and each intermediate piece comprises two opposite concave parts, each with a spherical surface, each concave part being able to receive a convex part of a segment to form a ball-and-socket joint. In this way, the guide device can comprise simple segments with two identical ends, for example each formed by a simple tube, for example cylindrical, with two identical end pieces, each with spherical surfaces, fitted at the ends of the tube. A chain with different segment lengths according to the desired maximum radii of curvature along the chain can then easily be obtained by varying the length of the segment tubes. In other embodiments, the segments comprise concave portions at the ends and the intermediate pieces comprise convex parts, or the segments and the intermediate pieces each comprise a concave part and a convex part.

In an embodiment, the chain comprises a cable extending all along the chain, passing through central passages in the segments and central passages in the intermediate pieces, to ensure the holding of the convex parts engaged in the concave parts.

According to an embodiment, the said cable is connected by a first downstream end to the downstream attachment system, the chain comprising at its downstream end a terminal element, the said terminal element and the downstream attachment system being articulated together by a ball-and-socket joint. In an embodiment, the cable is connected by its second upstream end to the last element at the upstream end of the chain, a nut for example being screwed onto the second threaded end of the cable and coming into abutment against the last element of the chain. Preferably, at least one compression spring system is interposed and/or integrated in the chain. This compression spring system at least allows any play between the segments and the intermediate pieces to be taken up. In an embodiment, the compression spring system puts the segments under tension, allowing the chain to return elastically to a substantially straight position. In an embodiment, several compression spring systems are provided along the chain.

According to an embodiment, the guide means comprise rings arranged along the chain and in which the conveying tube or tubes pass, each conveying tube preferably being able to move longitudinally in each guide ring in which it passes.

In an embodiment, the conveying means comprise a plurality of conveying tubes for individually conveying a plurality of fibers, the guide means comprising, from upstream to downstream along the chain, rings for guiding and distributing the conveying tubes around the chain, and then rings for progressively guiding the conveying tubes in the form of two parallel rows at the inlet to the downstream attachment system.

According to an embodiment, each conveying tube is provided with at least one longitudinal flexible blade, preferably of rectangular cross-section, each conveying tube and its associated flexible blade are placed in a second flexible holding tube, so that said holding tube holds said flexible blade against the conveying tube, while allowing relative longitudinal displacement of the flexible blade with respect to the conveying tube, each holding tube passing into the guide means of the guide device.

Another object of the present invention is a method for manufacturing a composite material part comprising the application of continuous fibers onto an application surface, characterized in that the application of fibers is carried out by means of a fiber application machine as described above, by relative displacement of the application head with respect to the lay-up surface along deposition trajectories.

### BRIEF DESCRIPTION OF THE DRAWINGS

The invention will be better understood, and other purposes, details, features and advantages will become clearer in the course of the following detailed explanatory description of a currently preferred particular embodiment of the invention, with reference to the annexed schematic drawings in which:

FIG. 1 is a schematic side view of a placement machine according to the invention;

FIG. 2 is a partial schematic cross-sectional view of the conveying means illustrating the conveying tubes, the upstream and downstream attachment systems, and the guide device for guiding the conveying tubes;

FIG. 3 is a partial perspective view of the conveying means in FIG. 2, at the level of the downstream attachment system;

FIG. 4 is a partial perspective view of the guide device;

FIG. 5 is an enlarged view of detail D1 in FIG. 2;

FIG. 6 is a schematic cross-sectional view of the guide device illustrating the inclination of the chain segments;

FIG. 7 is an enlarged view of detail D2 in FIG. 2; and,

FIG. 8 is an enlarged view of detail D3 in FIG. 2.

### DETAILED DESCRIPTION

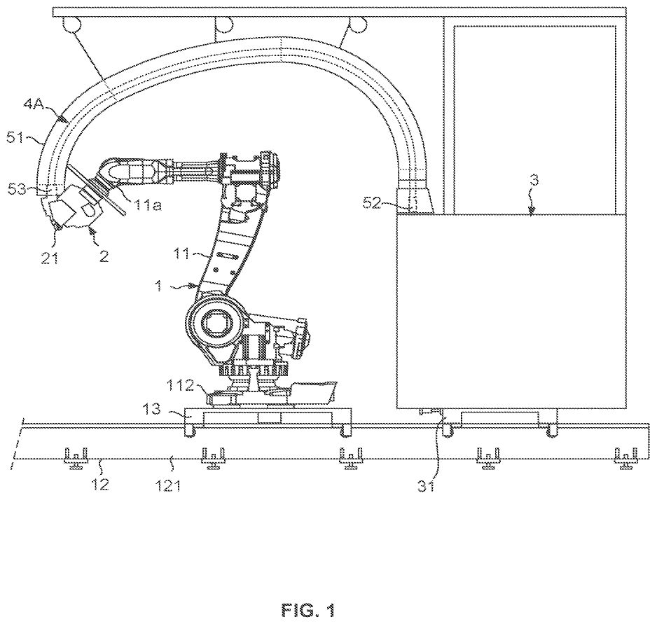

With reference to FIG. 1, the placement machine comprises a displacement system 1 formed by a polyarticulated arm 11, of the six-axis robot type, known per se, mounted so as to be mobile on a linear axis 12, an application head 2 mounted on the end wrist 11a of the poly-articulated arm, fiber storage means 3, conveying means for conveying fibers from the said storage means to the application head. The polyarticulated arm 11 is attached by its base 112 to a carriage 13 slidably mounted on the linear axis 12, said linear axis consisting of two parallel rails 121 fixed to the floor. The carriage is equipped with drive means, for example motorized rollers, controlled by a control unit for displacing the placement head along these rails. The fiber application head 2, also known as the fiber placement head, comprises an application roller 21 able to come into contact with a mold in order to apply a band formed from several fibers, for example pre-impregnated with resin. The machine is designed to apply fibers, for example carbon fibers, packaged in the form of spools. The storage means consist of a creel, schematically shown as reference 3, for receiving the fiber spools. The creel is also mounted on a follower carriage 31, arranged on the rails 121 and mechanically connected to the carriage 13 carrying the robot.

The conveying means comprise first flexible tubes, called conveying tubes, fitted with flexible stiffening blades. The fibers are fed individually through these feed tubes from the creel 3 to the fiber placement head 2. The tubes are brought together in a bundle, shown schematically as 4A in FIG. 1, and are placed in the internal passage of a flexible sheath 51. In the example shown, the machine is designed to apply a strip of eight fibers, so the conveying means comprise eight conveying tubes. With reference to FIG. 5, each conveying tube 41 has a wall with a rectangular cross-section, with two short sides and two long sides. The wall has an inner surface and a substantially flat outer surface. Each conveying tube is fitted externally, along substantially its entire length and along each of its long sides, with a flexible metal blade 42a, 42b, also called foil. The metal blades and the conveying tube are placed in a second flexible tube 43, called holding tube, which is substantially rectangular in cross-section so as to keep the blades substantially parallel to the outer surfaces of the long sides of the conveying tube, while allowing relative longitudinal movement of the blades with respect to the conveying tube. The holding tube 44 is, for example, a flexible corrugated tube of substantially rectangular cross-section, as described in the aforementioned patent document. The width of the blade is less than or equal to that of a long side, preferably less. The conveying tube fitted with its blades and placed in the holding tube is designated by reference 4. Each conveying tube is designed to receive a flat fiber in its internal passage of rectangular cross-section, substantially parallel to its long sides, and therefore parallel to the metal blades. The metal blades prevent any transverse flexion of the feed tube in the plane of the blade, but allow longitudinal flexion of the feed tube in a direction perpendicular to the planes of the blades, as well as torsion of the feed tube. When the robot is moved for fiber placement operations, the feed tubes will be deformed by flexion perpendicularly to the plane of the blade and/or torsion, so that the fiber remains flat parallel to the metal blades.

The ends of the conveying tubes are connected to the creel 3 and the head respectively by an upstream attachment system 52 and a downstream attachment system 53. Each conveying tube is connected in a fixed manner, i.e. fixed without freedom of movement, by its end portion to the upstream attachment system 52, and connected in a longitudinally mobile manner, i.e. attached with freedom of longitudinal movement, to the downstream attachment system 53. One of the blades associated with the conveying tube is fixedly assembled, by its upstream end portions, to the downstream attachment system and to the downstream attachment system. The other flexible blade is fixedly assembled to one of the attachment systems, and movable in longitudinal translation, i.e. attached with a freedom of longitudinal displacement, to the other attachment system, for example fixedly by its downstream end portion to the downstream attachment system, and movably in longitudinal translation, by its upstream end portion to the upstream attachment system. The upstream attachment system 52 is similar to that described in the aforementioned patent document, and comprises for each conveying tube a longitudinal main passage, in which a conveying tube 41 is mounted by its upstream end portion. In the present embodiment, the main passages are arranged in a row, the conveying tubes being assembled in a row at the upstream attachment system. Secondary passages are provided for mounting the flexible blades associated with each conveying tube. On the placement head side, the conveying tubes are assembled in two rows at the upstream attachment system 53, so as to form two superimposed bundles of fibers at the head inlet. The upstream attachment system comprises a main passage 531 for each conveying tube, in which a conveying tube 41 is slidably mounted by its downstream end portion. The main passages are arranged in two superimposed rows. Secondary passages 532a, 532b are arranged on either side of the main passage for the mounting of the flexible blades associated with the conveying tube.

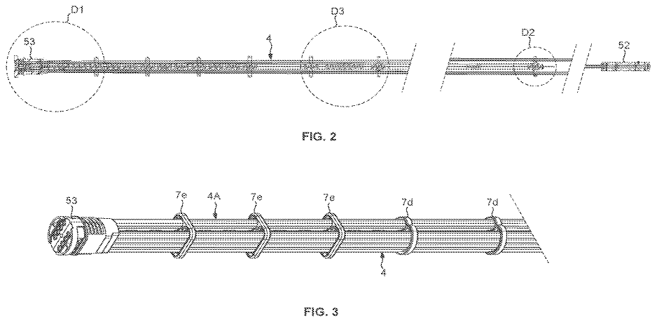

According to the invention, the conveying means also comprise a guide device for guiding the conveying tubes in order to control their radius of curvature, particularly at the downstream attachment system. With reference to FIGS. 2 to 6, the guide device is formed by a chain comprising a succession of rigid segments 6 mounted so as to be articulated to one another via articulation systems 7 of the ball-and-socket joint type. The chain is connected by a downstream end to the downstream attachment system 53 and extends in the direction of the upstream attachment system 52. In the present embodiment, the chain does not extend up to the upstream guide system; the upstream end of the chain is arranged between the downstream guide system and the upstream guide system, for example halfway between the two. The articulation systems comprise intermediate pieces 7 inserted between two successive segments, each segment being articulated by a ball-and-socket joint to an intermediate piece, two successive segments thus being connected together by two ball-and-socket joints via the intermediate piece.

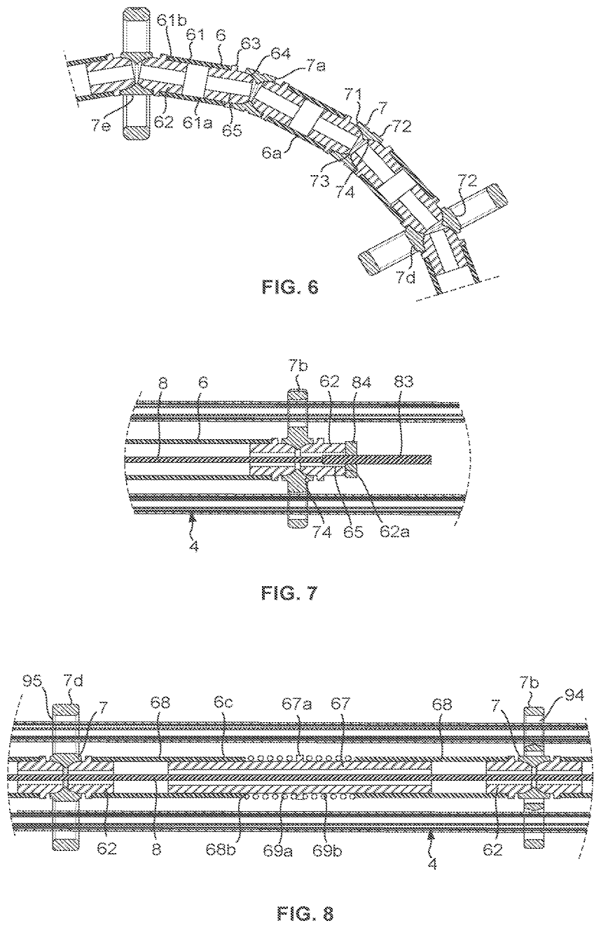

Referring in particular to FIG. 6, each segment 6 is formed by a cylindrical tube 61, for example made of metal, in particular aluminum. At each end of the tube, an end-piece 62, for example made of plastic, provided with a collar 63 is force-fitted into the central passage 61a of the tube, the end-piece coming by its collar into abutment against the circular edge 61b of the tube. Each end piece has an external convex part 64 with a spherical surface, and has a central longitudinal passage 65. Each intermediate piece 7 is in the form of a ring comprising two opposite circular edges 71, an outer wall 72 and an inner wall defining the central passage 73 of the intermediate piece. The inner wall comprises two opposing concave parts 74 each opening onto a circular edge 71. Each concave part has a spherical surface complementary in shape to that of the spherical surface of the convex parts 64. In the present embodiment, the spherical surfaces of the concave parts and the convex parts each consist of a spherical segment, which makes it possible to have a compact articulation system.

The chain is thus formed by alternating segments 6 and intermediate pieces 7, with each convex part 64 of a segment penetrating into a concave part 74 of an intermediate piece to form a ball-and-socket joint. The collar 63 of the segment acts as a stop and limits the pivoting of the segment by abutting against the edge 71 of the intermediate piece, as shown in FIG. 6. By way of example, the collar limits the inclination between a segment and an intermediate piece to a maximum angle of approximately 7°.

The segments and intermediate pieces are held together by a cable 8, for example a metal cable, which extends from one end of the chain to the other, passing through the central passages 65 of the end pieces, the central passages 61a of the tubes and the central passages 73 of the intermediate pieces. The downstream end 81 of the cable is connected to the downstream attachment system 53. By way of example, with reference to FIG. 5, the downstream end 81 of the cable is threaded, the assembly being obtained by one or more nuts 82 screwed onto the threaded downstream end of the cable, and positioned in housings in the downstream attachment system. At the downstream end of the chain, the chain is terminated, for example, by a specific terminal end piece 66 comprising two opposing convex parts, this terminal end piece being fitted on the upstream side into a concave part 74 of an intermediate piece 7, and on the downstream side into a concave part 533 of the attachment system. The threaded downstream end 81 of the cable emerging from the central passage of this specific end fitting passes into a central passage 534 of the downstream attachment system which opens onto this concave part 533. This assembly with a specific end piece makes it possible to offer a compact downstream attachment system. Alternatively, the downstream end of the chain ends in a segment 6 with its two convex parts 64, one fitted into the concave part 74 of the intermediate piece and the other into the concave part 533 of the downstream attachment system. At the upstream end of the chain, with reference to FIG. 7, the chain ends in a terminal end-piece 62, identical to those used to form the segments 6, this terminal end-piece is fitted by its convex part into a concave part of an intermediate piece, the upstream end 83 of the cable is threaded, and protrudes from the central passage 65 of the terminal end-piece. A nut 84 is screwed onto this threaded upstream end and comes into abutment against the circular edge 62a of the terminal end piece.

Referring to FIG. 8, the chain comprises a particular segment 6c equipped with a compression spring system to take up any play between the segments. This particular segment 6c arranged between two intermediate piece 7 comprises two tubes 68 mounted sliding by one end on a tubular sleeve 67 provided with a collar 67a, each tube 68 is equipped at its other end with an end piece 62 which is housed in a concave part 74 of one of the two intermediate piece between which the segment is positioned. Two compression springs 69a, 69b are mounted on the sleeve 67 between the two tubes 68, each spring bearing on one side against the collar 67a and on the other side against the circular edge 68b of a tube. The nut 84 is screwed onto the upstream end 83 of the cable until the springs are prestressed.

The guide device further comprises guide means distributed along the chain in which the conveying tubes 41 equipped with their flexible blades 42a, 42b and placed in holding tubes 43 pass. These guide means are formed by rings 9 arranged on the external wall 72 of certain intermediate pieces 7 along the chain, the rings and the intermediate piece preferably being formed from a single piece, for example made of plastic material. The intermediate pieces may comprise several rings each intended for the passage of a holding tube surrounding a conveying tube and its two associated blades, or one or more rings each intended for the passage of several holding tubes. The internal passages 91 of the rings of an intermediate piece have main axes arranged parallel to the main axis of the central passage 73 of the intermediate piece. The rings are used to guide the holding tubes around the chain, while allowing longitudinal movement of the holding tubes in their internal passage when the conveying means are moved as a result of a head displacement by the robot. Furthermore, the ball joints between two segments and an intermediate piece allow rotation of the intermediate piece relative to the segments during head displacements.

In this embodiment, the chain comprises two types of segment. On the downstream attachment system side, the chain comprises a succession of short segments 6a to allow significant curvature of the conveying tubes at the robot's wrist, extending by a succession of long segments 6b.

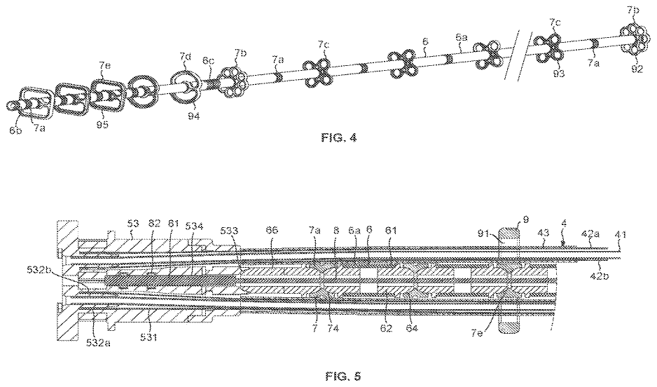

With reference to FIG. 4, the chain comprises different types of intermediate piece:
intermediate pieces 7a without a ring;
intermediate pieces 7b, comprising eight rings 91 distributed at regular angular space on their external wall, each ring being intended to receive in its internal passage, of substantially circular section, a holding tube, in which is placed a conveying tube and two blades;
intermediate pieces 7c comprising only four rings 93 distributed at regular angular space on their external wall to individually receive four of the eight holding tubes;
intermediate pieces 7d comprising two diametrically opposed rings 94, each having an internal passage having a generally circular sector section, to receive four holding tubes; and,
intermediate pieces 7e comprising two diametrically opposed rings 95 each having an internal passage of generally rectangular section to receive four holding tubes.

The conveying tubes exiting the upstream attachment system are arranged side by side in a single row and must be brought in two superimposed rows in the downstream attachment system. The holding tubes, each containing a conveying tube and its two associated blades, exit in a row from the upstream attachment system and extend freely in the sheath 51 to the downstream end of the chain. At this downstream end, the chain comprises an intermediate piece 7b with eight rings 92, each holding tube passes through a ring. Then, the chain comprises an alternation of intermediate pieces 7a without a ring and intermediate pieces 7c with four rings 93. For two successive intermediate pieces 7c with four rings in the chain, four holding tubes among the eight holding tubes pass through the rings 93 of the first intermediate piece 7c, then the other four holding tubes pass through the four rings of the following intermediate piece. Then, on the last section of chain near the robot's wrist, the chain successively comprises from upstream to downstream an intermediate piece 7b with eight rings to individually receive the eight holding tubes, then two intermediate pieces 7d with two rings 94 in a circular sector, and three intermediate pieces 7e with two rings 95 of rectangular section. This arrangement of the guide means on this last section of chain makes it possible to progressively guide the eight holding tubes in two rows of holding tubes one above the other.

Although the invention has been described in connection with a particular embodiment, it is quite obvious that it is in no way limited thereto and that it includes all the technical equivalents of the means described as well as their combinations if these fall within the scope of the invention.

1. Fiber application machine comprising a fiber application head, fiber storage means, and conveying means for conveying at least one fiber from the storage means to the application head, the conveying means comprising at least one flexible conveying tube, able to receive a fiber in its internal passage, each conveying tube is mounted by a downstream end to a downstream attachment system mounted on the application head and by an upstream end to an upstream attachment system, wherein the conveying means further comprise a guiding device comprising
a chain comprising a succession of rigid segments mounted so as to be articulated to one another via articulation systems, the said-chain extending from an upstream end to a downstream end by which the said chain is connected to the downstream attachment system, and
guide means distributed along the chain through which the conveying tube or tubes pass.

2. The machine according to claim 1, wherein the chain comprises rigid segments mounted so as to be articulated to one another via articulation systems of the ball-and-socket joint type, each articulation system comprising stop means for limiting the inclination between two successive segments.

3. The machine according to claim 2, wherein the articulation system comprises a rigid intermediate piece interposed between two successive segments, an intermediate piece and a segment being articulated together by a ball-and-socket joint, for each ball-and-socket joint, a first element among the intermediate piece and the segment is provided with a convex part having a spherical surface, the other element being provided with a concave part having a spherical surface and able to receive the convex part, intermediate pieces being equipped with the guide mean.

4. The machine according to claim 3, wherein the segments comprise two convex parts at their ends, each having a convex surface, each intermediate piece comprises two opposite concave parts each having a spherical surface, each concave part being able to receive a convex part of a segment in order to form a ball-and-socket joint.

5. The machine according to claim 3, wherein the chain comprises a cable extending throughout the chain, passing through central passages of the segments and central passages of the intermediate pieces, to ensure the holding of the convex parts engaged in the concave parts.

6. The machine according to claim 5, wherein the cable is connected by a first downstream end to the downstream attachment system, the chain comprising at its downstream end a terminal element the terminal element and the downstream attachment system being articulated together by a ball-and-socket joint.

7. The machine according to claim 1, wherein the guide means comprise rings arranged along the chain and through which the conveying tube or tubes pass.

8. The machine according to claim 1, wherein the conveying means comprise a plurality of conveying tubes for individually conveying a plurality of fibers, the guide means comprising, from upstream to downstream along the chain, rings for guiding and distributing the conveying tubes around the chain, and then rings for progressively guiding the conveying tubes in the form of two parallel rows at the inlet to the downstream attachment system.

9. The machine according to claim 1, wherein each conveying tube is provided with at least one longitudinal flexible blade, each conveying tube and its associated flexible blade are placed in a second flexible holding tube, each holding tube passing in the guide means of the guide device.

10. The method for manufacturing a composite material part comprising the application of continuous fibers onto an application surface, wherein the application of fibers is carried out by means of a fiber application machine according to claim 1, by relative displacement of the application head with respect to the lay-up surface according to deposition trajectories.
